(19) United States
(12) Patent Application Publication
(10) Pub. No.: US 2022/0344742 A1
(43) Pub. Date: Oct. 27, 2022

(54) BATTERY CASE AND METHOD FOR MANUFACTURING THE SAME

(71) Applicant: TOYOTA JIDOSHA KABUSHIKI KAISHA, Toyota-shi (JP)

(72) Inventor: Fumio NOMIZO, Toyota-shi (JP)

(73) Assignee: TOYOTA JIDOSHA KABUSHIKI KAISHA, Toyota-shi (JP)

(21) Appl. No.: 17/717,746

(22) Filed: Apr. 11, 2022

(30) Foreign Application Priority Data
Apr. 26, 2021 (JP) 2021-074243

(51) Int. Cl. H01M 10/653; H01M 10/613; H01M 50/209

(52) U.S. Cl. CPC H01M 10/653; H01M 10/613; H01M 50/209

(57) ABSTRACT

A battery case includes: a case main body which includes a case bottom wall part, and a case sidewall part which is connected to a circumference part of the case bottom wall part, and defines together with the case bottom wall part a battery housing part for housing a battery module, the case bottom wall part including an opening part which makes the battery housing part and an outside of the case main body communicate; a cooler which is arranged so as to face an outer side of the case bottom wall part; and an insulation sheet which is arranged between the cooler and the case bottom wall part, and covers the opening part.

### CROSS REFERENCE TO RELATED APPLICATIONS

This application claims benefit of priority based on Japanese Patent Application No. 2021-074243, filed on Apr. 26, 2021, the entire contents of which are incorporated herein by reference.

### BACKGROUND

### Field

The present disclosure relates to a battery case and a method for manufacturing the battery case.

### Related Art

An assembled battery in which a plurality of batteries are housed in a battery housing part of a separator arranged in a retaining plate is known (e.g., JP2012-094312A). A plurality of batteries are arranged on a heat exchange face of a cooling plate with heat conduction sheets interposed therebetween and arranged in opening parts provided in the separator.

In the assembled battery having the above structure, there is a probability that, due to, for example, an influence of a manufacturing error or thermal expansion of the separator, liquid water enters the battery housing part from an outside of the separator through the opening parts.

### SUMMARY

One aspect of the present disclosure provides a battery case. This battery case includes: a case main body that includes a case bottom wall part, and a case sidewall part, wherein the case sidewall part is connected to a circumference part of the case bottom wall part and defines together with the case bottom wall part a battery housing part for housing a battery module, wherein the case bottom wall part includes an opening part, wherein the battery housing part communicates with an outside of the case main body through the opening part; a cooler that is arranged so as to face an outer side of the case bottom wall part; and an insulation sheet that covers the opening part, wherein the insulation sheet is arranged between the cooler and the case bottom wall part.

According to the battery case of this aspect, the insulation sheet is arranged between the cooler and the case bottom wall part and covers the opening part, and thereby the opening part is blocked by the insulation sheet, so that it is possible to reduce or prevent liquid water from entering the battery housing part from the outside of the case main body through the opening part.

### BRIEF DESCRIPTION OF THE DRAWING

FIG. 1 is a perspective view illustrating a power storage device;

FIG. 2 is an exploded perspective view illustrating an internal structure of the power storage device;

FIG. 3 is a cross-sectional view at a position illustrated in FIG. 1;

FIG. 4 is a perspective view illustrating a cooler with an insulation sheet arranged thereon;

FIG. 5 is an explanatory view illustrating in plan view the cooler with the insulation sheet arranged thereon;

FIG. 6 is an explanatory view illustrating in plan view an outer face of a case bottom wall part;

FIG. 7 is an enlarged view of part of an area in FIG. 3;

FIG. 8 is a process view illustrating a method for manufacturing the power storage device;

FIG. 9 is a process view illustrating a method for manufacturing the battery case;

FIG. 10 is a perspective view illustrating a state where a frame body is assembled to the cooler with the insulation sheet arranged thereon;

FIG. 11 is a cross-sectional view illustrating an assembly with a mold attached thereto;

FIG. 12 is an explanatory view illustrating a state where a case main body is formed in the assembly;

FIG. 13 is a cross-sectional view at an XIII-XIII position in FIG. 12; and

FIG. 14 is a perspective view illustrating how heat conducting members and a battery module are arranged in the case main body.

### DETAILED DESCRIPTION

A. First Embodiment:

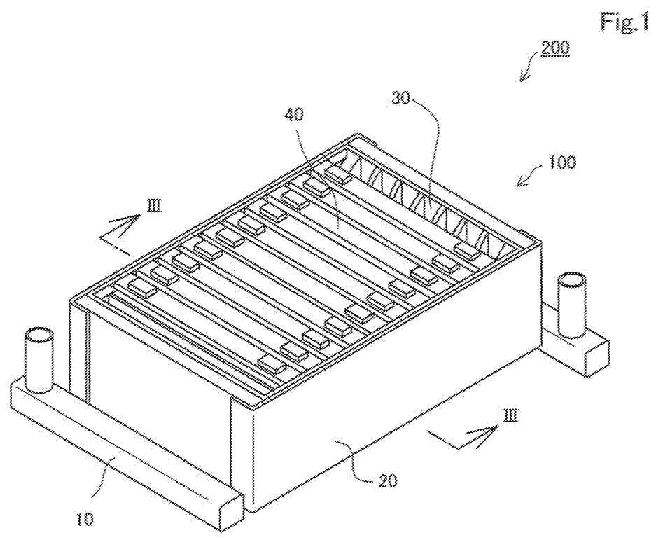

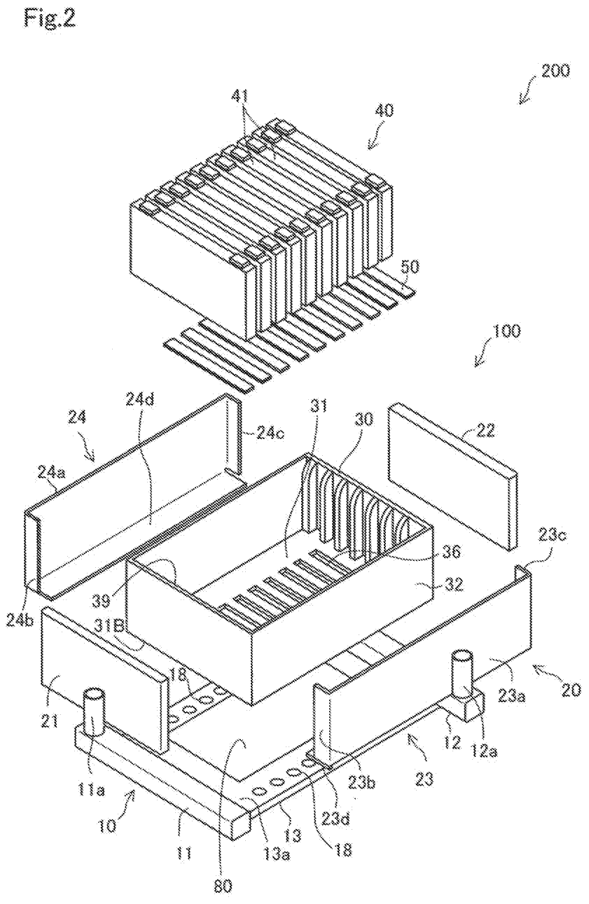

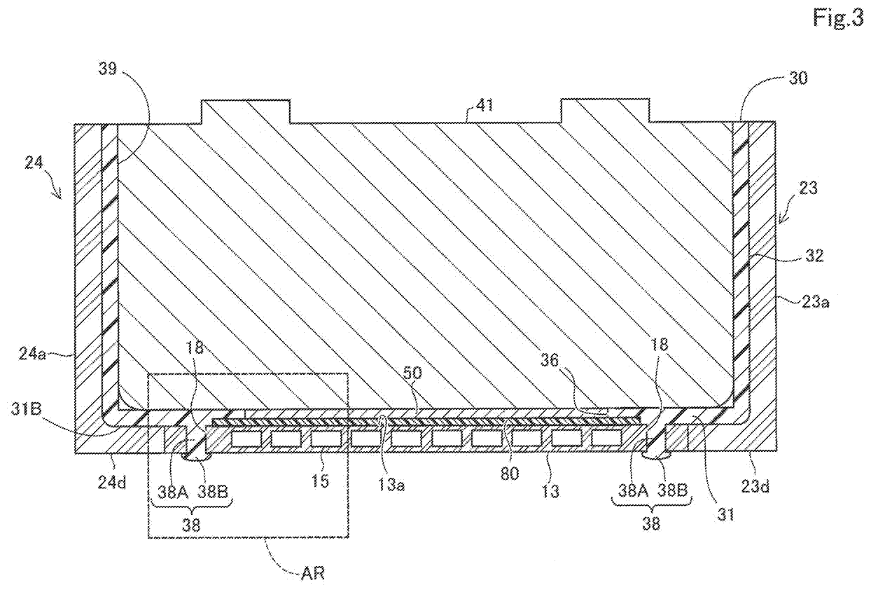

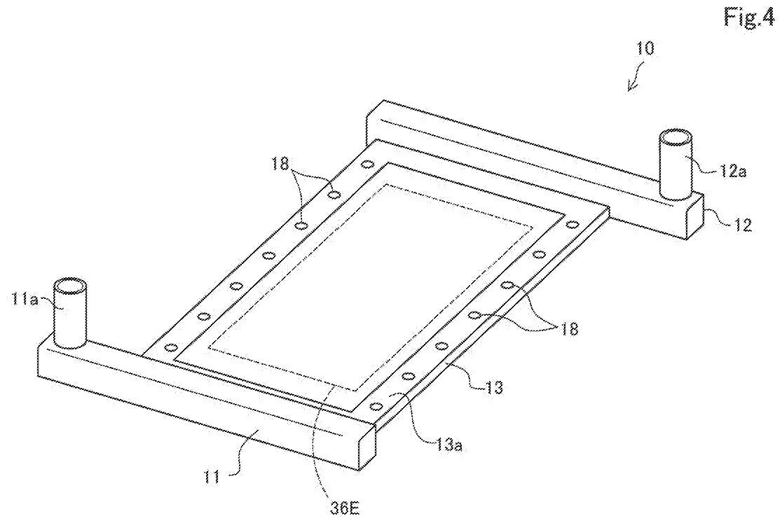

A power storage device 200 including a battery case 100 according to the first embodiment of the present disclosure will be described with reference to FIGS. 1 to 4. FIG. 1 is a perspective view illustrating the power storage device 200. FIG. 2 is an exploded perspective view illustrating an internal structure of the power storage device 200. FIG. 3 is a cross-sectional view at a position illustrated in FIG. 1. FIG. 4 is a perspective view illustrating a cooler 10 with an insulation sheet 80 arranged thereon.

The power storage device 200 is an in-vehicle battery system which is mounted on a hybrid vehicle which uses at least one prime mover of, for example, an electric motor and an internal combustion engine as a driving source, or an electric vehicle which travels using a driving force obtained from electric energy. As illustrated n FIGS. 1 and 2, the power storage device 200 includes a battery module 40, a frame body 20, heat conducting members 50 and the battery case 100. As illustrated in FIG. 2, the battery case 100 according to the present embodiment includes a case main body 30, the cooler 10 and the insulation sheet 80.

The battery module 40 includes a plurality of battery cells 41. The battery cell 41 is a secondary battery such as a nickel-metal hydride battery or a lithium ion battery. An arbitrary number of the battery cells 41 matching, for example, an output voltage requested by the power storage device 200 are provided. In an example in FIG. 2, the number of the battery cells 41 is 10. The battery cell 41 has, for example, a square external shape. The battery cells 41 are linearly aligned in a battery housing part 39 of the case main body 30. The battery cell 41 is not limited to the square shape, and may have an arbitrary shape such as a cylindrical shape. The battery cell 41 may use a liquid electrolyte, or may use a solid electrolyte. The battery cell 41 is not limited to the secondary battery, and may be, for example, a capacitor which can store electric power.

The frame body 20 is a metal member for reinforcing the case main body 30. The frame body 20 is arranged so as to surround an outer circumferential face of a case sidewall part 32 of the case main body 30. The frame body 20 includes a pair of end plates 21 and 22 and a pair of restraint plates 23 and 24. The frame body 20 may not be provided in a case where the battery case 100 has sufficient strength.

The end plates 21 and 22 are substantially flat members. The end plates 21 and 22 are arranged so as to face each other across the case main body 30. The restraint plates 23 and 24 are arranged so as to face each other across the case main body 30 in a direction orthogonal to an alignment direction of the end plates 21 and 22.

The restraint plates 23 and 24 sandwich and restrain the end plates 21 and 22 between the restraint plates 23 and 24 and the case main body 30. The restraint plate 23 includes a plate main body 23a, engaging piece parts 23b and 23c and a bottom face part 23d. The plate main body 23a is a flat member which is arranged along the outer circumferential face of the case sidewall part 32 of the case main body 30. The engaging piece parts 23b and 23c are parts which continue from both ends of the plate main body 23a of the restraint plate 23, and are bent toward the restraint plate 24. The bottom face part 23d is a part which continues from an end side which is one of end sides of the plate main body 23a of the restraint plate 23 and is at a position close to the cooler 10, and is bent toward the restraint plate 24. The bottom face part 23d is provided flush with a case facing face 13a of the cooler 10.

The restraint plate 24 includes a plate main body 24a, engaging piece parts 24b and 24c and a bottom face part 24d. The plate main body 24a is a flat member which is arranged along the case sidewall part 32 of the case main body 30. The engaging piece parts 24b and 24c are parts which continue from both ends of the plate main body 24a of the restraint plate 24, and are bent toward the restraint plate 23. The bottom face part 24d is a part which continues from an end side which is one of end sides of the plate main body 24a of the restraint plate 24 and is at a position close to the cooler 10, and is bent toward the restraint plate 23. The bottom face part 24d is provided flush with the case facing face 13a of the cooler 10. When the engaging piece parts 23b and 23c engage with end parts of the end plates 21 and 22, and the engaging piece parts 24b and 24c engage with end parts of the end plates 21 and 22, a pair of end plates 21 and 22 and the case main body 30 are restrained by a pair of restraint plates 23 and 24.

The case main body 30 is a box-like member provided on an inner side of the frame body 20, and houses the battery module 40. The case main body 30 is formed by injection molding which uses a resin material having an insulation property as described later. In the present embodiment, the case main body 30 is formed by using polyethylene-telephthalate (PET).

The resin material for forming the case main body 30 may be further mixed with reinforced. fibers such as glass fibers or carbon fibers from viewpoint to improve strength of the case main body 30. The material of the case main body 30 is not limited to PET, and various resin materials such as polypropylene (PP), and nylon-based and acrylic-based materials may be used. As described later, the material of the case main body 30 preferably contains a resin material of the same type as that of the insulation sheet 80 to improve adhesiveness with respect to the insulation sheet 80.

The case main body 30 includes a case bottom wall part 31 of a flat shape and the case sidewall part 32 which surrounds the case bottom wall part 31. The case sidewall part 32 is connected to a circumference part of the case bottom wall part 31, and extends toward a normal direction of the case bottom wall part 31. The case sidewall part 32 and the case bottom wall part 31 define the battery housing part 39 for housing the battery module 40. The battery housing part 39 corresponds to an interior of the case main body 30. An outer surface of the case sidewall part 32 is in contact with an inner surface of the frame body 20. The inner surface of the case sidewall part 32 may be provided with ribs for positioning the battery cells 41.

The case bottom wall part 31 includes a plurality of opening parts 36. The opening parts 36 make the battery housing part 39 and the outside of the case main body 30 communicate. In the present embodiment, the number of the opening parts 36 is the same as the number of the battery cells 41 included in the battery module 40 housed in the battery housing part 39, and is 10 in the example in FIG. 2. The opening part 36 functions a heat radiation route from the battery module 40 to the cooler 10. In the present embodiment, the heat conducting members 50 are arranged on the opening parts 36.

The heat conducting member 50 is a member which has an insulation property and thermal conductivity. The heat conducting member 50 transfers heat of the battery module 40 to the cooler 10, and electrically insulates the battery module 40 and the cooler 10. In the present embodiment, an adhesive in a paste state which uses a silicone-based resin material is used for the heat conducting members 50. The heat conducting member 50 preferably has elasticity to enhance adhesion of the battery module 40 and the cooler 10. The heat conducting member 50 is not limited to the silicon-based resin material, and various resin materials such as acrylic-based, urethane-based and epoxy-based resin materials may be used. The heat conducting member 50 is not limited to a paste state, and may be a sheet state. The heat conducting member 50 may be omitted in a case where the battery case 100 has sufficient heat radiation capability.

The cooler 10 is arranged so as to face an outer side of the case bottom wall part 31 of the case main body 30. The cooler 10 cools the battery module 40. The cooler 10 is formed from metal such as aluminum or an aluminum alloy having high thermal conductivity. As illustrated in FIG. 2, the cooler 10 has a substantially flat external shape. A face of the cooler 10 facing the case bottom wall part 31 is also referred to as the case facing face 13a.

As illustrated in FIG. 4, the cooler 10 includes a coolant supply passage 11, a coolant discharge passage 12 and a main body part 13. The coolant supply passage 11 is arranged at one end of the main body part 13, and the coolant discharge passage 12 is arranged at the other end of the main body part 13. The coolant supply passage 11 is provided with a coolant supply port 11a for supplying a coolant into the main body part 13, and the coolant discharge passage 12 is provided with a coolant discharge port 12a for discharging the coolant. The coolant supply port 11a and the coolant discharge port 12a are connected to an unillustrated coolant circulation passage for circulating the coolant in the cooler 10.

As illustrated in FIG. 3, coolant flow passages 15 for causing the coolant to flow are provided inside the main body part 13 of the cooler 10. The coolant supplied from the coolant supply port 11a passes through the coolant flow passages 15 in the main body part 13, and is discharged from the coolant discharge port 12a to the coolant circulation passage. When the coolant flows in the coolant flow passages 15, the battery module 40 is cooled.

As illustrated in FIG. 4, fitting holes 18 are formed in the main body part 13. The fitting holes 18 are through-holes which penetrate from the case facing face 13a of the main body part 13 to a face opposite to the case facing face 13a, i.e., the main body part 13 in a thickness direction. In the present embodiment, the main body part 13 includes the plurality of fitting holes 18. More specifically, the seven fitting holes 18 are linearly aligned respectively at positions on both sides of the insulation sheet 80 along an extension direction of the main body part 13. The fitting holes 18 fit with projecting parts 38 provided on the case bottom wall part 31 of the case main body 30. In a case where, for example, the case main body 30 is stably fixed to the cooler 10, the fitting holes 18 may not be provided. The number of the fitting holes 18 can be set to an arbitrary number, is not limited to a plural number, and may be one.

As illustrated in FIG. 3, the projecting parts 38 are provided on an outer face 31B of the case bottom wall part 31 of the case main body 30. The projecting parts 38 are parts which project from the outer face 31B of the case bottom wall part 31, and are formed integrally with the case main body 30 when the case main body 30 is formed. The projecting part 38 includes a columnar part 38A and a flange part 38B. The columnar part 38A is a part which is inserted in the fitting hole 18 formed in the main body part 13 of the cooler 10. The flange part 38B is a part which has a larger cross-sectional width than a cross-sectional width of the columnar part 38A.

The flange part 38B is provided by being exposed from the face opposite to the case facing face 13a of the main body part 13 of the cooler 10. The flange part 38B and the outer face 31B of the case bottom wall part 31 sandwich the main body part 13 of the cooler 10 to reduce or prevent the columnar parts 38A from falling from the fitting holes 18.

As illustrated in FIG. 4, the insulation sheet 80 is arranged on the case facing face 13a of the main body part 13 of the cooler 10. The insulation sheet 80 is arranged on the case facing face 13a of the cooler 10 so as to cover an arrangement area 36E of the opening parts 36 as described below while avoiding the fitting holes 18.

As illustrated in FIG. 3, the insulation sheet 80 is arranged between the case facing face 13a of the cooler 10 and the outer face 31B of the case bottom wall part 31. The insulation sheet 80 is arranged so as to cover the opening parts 36 on the outer face 31B of the case bottom wall part 31. As a result, the insulation sheet 80 blocks the opening parts 36 on the outer face 31B of the case bottom wall part 31. Blocking the opening parts 36 means sealing the opening parts 36. The insulation sheet 80 has a function of electrically insulating the battery module 40 and the cooler 10. Hence, the insulation sheet 80 is preferably made of a material having a high insulation property. Furthermore, the insulation sheet 80 blocks the opening parts 36, and thereby reduces or prevents liquid water from an outside of the case main body 30 from entering the battery housing part 39 through the opening parts 36. Hence, the insulation sheet 80 is preferably made of a material having a high waterproof property. Since the insulation sheet 80 is provided on the heat radiation routes from the battery module 40 to the cooler 10, the insulation sheet 80 is preferably made of a material having high thermal conductivity. In view of the above, for example, a resin material such as PET, PP or an acrylic-based resin is preferably used for the insulation sheet 80. In the present embodiment, PET which is a resin material of the same type as that of the case main body 30 is used as the material of the insulation sheet 80. The insulation sheet 80 may contain PP instead of or together with PET. Even the insulation sheet 80 according to this aspect can provide an effect similar to that of the battery case 100 according to the present embodiment.

In the present embodiment, the insulation sheet 80 further contains a resin material having adhesiveness in addition to PET. By making the insulation sheet 80 in this way, it is possible to adhere the insulation sheet 80 onto the case facing face 13a of the cooler 10 by, for example, thermocompression bonding. The insulation sheet 80 may be adhered onto the cooler 10 by coating an adhesive on the cooler 10. As described later, from a viewpoint that the insulation sheet 80 is sandwiched between and fixed by the case main body 30 and the cooler 10 when the case main body 30 is formed by injection molding, the insulation sheet 80 may be arranged on the cooler 10 by, for example, coating a grease on the cooler 10. A method for fixing the insulation sheet 80 onto the cooler 10 is not limited to the above aspect, and may be arranged on the cooler 10 by various methods such as a method for pasting to the cooler 10 the insulation sheet 80 which is like an adhesive tape coated with an adhesive, and a method for performing thermocompression bonding on the insulation sheet 80 to which a resin material having adhesiveness is not added, and fixing the insulation sheet 80 to the cooler 10.

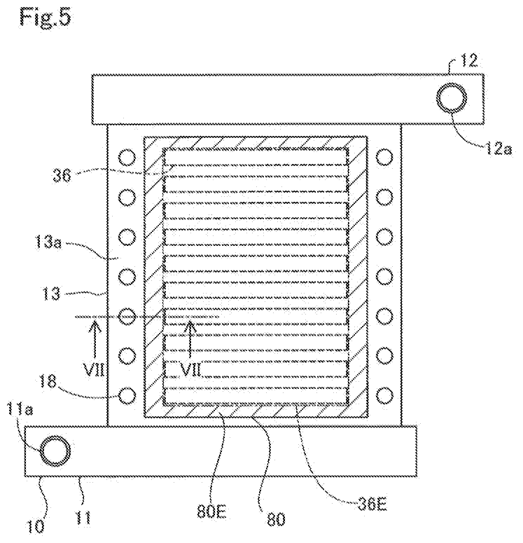

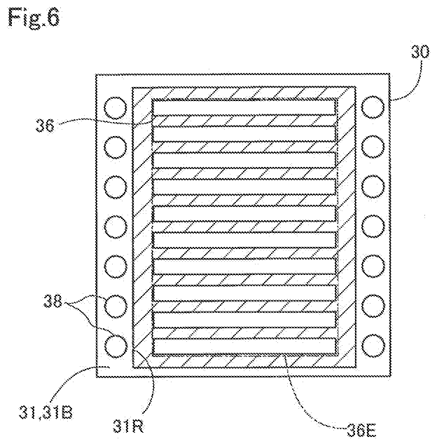

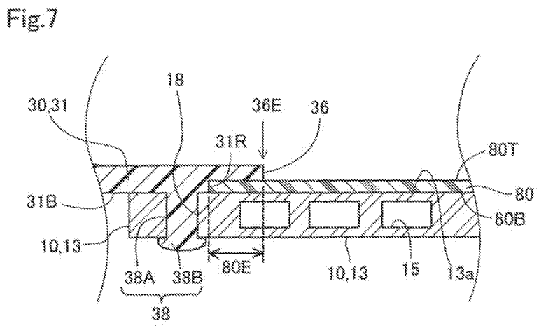

An arrangement relationship between the case main body 30 and the insulation sheet 80 will be described with reference to FIGS. 5 to 7. FIG. 5 is an explanatory view illustrating in plan view the cooler 10 with the insulation sheet 80 arranged thereon. FIG. 5 schematically illustrates arrangement positions of the opening parts 36 of the case main body 30 by using broken lines for ease of understanding of the technique. FIG. 6 is an explanatory view illustrating in plan view the outer face 31B of the case bottom wall part 31. FIG. 7 is an enlarged view of part of an area AR in FIG. 3. A position of a cross-sectional view illustrated in FIG. 7 corresponds to a VII-VII position illustrated in FIG. 5. FIG. 7 omits illustration of the battery module 40, the heat conducting members 50 and the frame body 20.

As illustrated in FIG. 5, the insulation sheet 80 has a substantially rectangular external shape in plan view. FIGS. 5 and 6 schematically illustrate by a dashed line the arrangement area 36E in which the plurality of opening parts 36 are arranged. The plurality of opening parts 36 are linearly aligned in the arrangement area 36E. The insulation sheet 80 is arranged on the case facing face 13a of the cooler 10 so as to cover the arrangement area 36E while avoiding the fitting holes 18. As a result, the insulation sheet 80 covers all of the plurality of opening parts 36, and block all of the plurality of opening parts 36 on an outer surface of the case bottom wall part 31.

FIG. 5 schematically illustrates a circumference part 80E of the insulation sheet 80 by hatching the circumference part 80E for ease of understanding of the technique. The circumference part 80E is an area which is a predetermined distance from an outer circumferential end of the insulation sheet 80 to a center of the insulation sheet 80, and is an area from the outer circumferential end of the insulation sheet 80 to a position which reaches the arrangement area 36E in the present embodiment.

As illustrated in FIGS. 6 and 7, a recessed part 31R is provided on the outer face 31B of the case bottom wall part 31. FIG. 6 illustrates a range in which the recessed part 31R is formed on the outer face 31B of the case bottom wall part 31 by hatching the range for ease of understanding of the technique. As illustrated in FIG. 6, the recessed part 31R is formed over a range including the arrangement area 36E on the outer face 31B of the case bottom wall part 31. As illustrated n FIG. 7, the recessed part 31R is a part of the outer face 31B of the case bottom wall part 31 whose thickness is formed thinner than other parts of the case bottom wall part 31. The recessed part 31R houses the insulation sheet 80. The depth of the recessed part 31R is formed to correspond to the thickness of the insulation sheet 80 such that the outer face 31B of the case bottom wall part 31 and a cooler facing face 80B which is a face of the insulation sheet 80 facing the cooler 10 are flush.

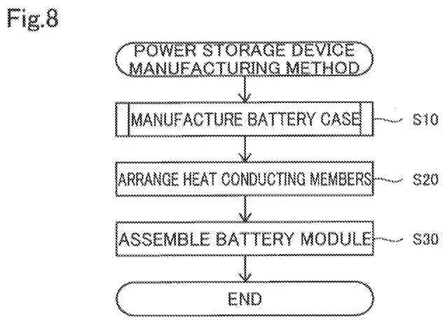

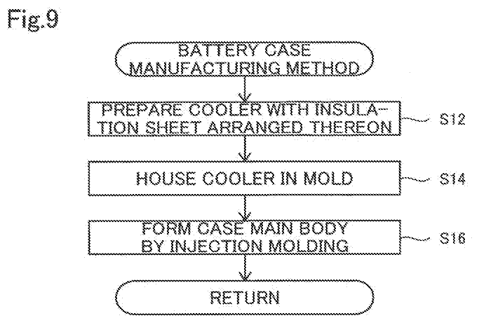

A method for manufacturing the power storage device 200 and the case main body 30 according to the present embodiment will he described with reference to FIGS. 8 to 14. FIG. 8 is a process view illustrating the method for manufacturing the power storage device 200. FIG. 9 is a process view illustrating the method for manufacturing the battery case 100.

As illustrated in FIG. 8, in step S10, the battery case 100 according to the present embodiment is manufactured. In step S20, the heat conducting members 50 are arranged on the opening parts 36 formed in the case bottom wall part 31 of the case main body 30. In step S30, the battery module 40 is assembled to the battery housing part 39 of the battery case 100. More specifically, when the battery module 40 is assembled to the battery housing part 39 provided in the case main body 30 of the battery case 100, the power storage device 200 is finished.

As illustrated in FIG. 9, according to the method for manufacturing the battery case 100 according to the present embodiment, in step S12, the cooler 10 with the insulation sheet 80 arranged on the case facing face 13a of the main body part 13 is prepared as illustrated in FIG. 4. More specifically, the insulation sheet 80 is arranged on and subjected to thermocompression bonding to the case facing face 13a to adhere the insulation sheet 80 onto the case facing face 13a. In step S14, the cooler 10 with the insulation sheet 80 arranged thereon is assembled in a mold for injection molding. In addition, in the present embodiment, an assembly in which the frame body 20 has been assembled to the cooler 10 with the insulation sheet 80 arranged thereon is assembled in the mold. In step S16, the case main body 30 is formed by injection molding. More specifically, the resin material is filled in the mold with the assembly housed therein to form the case main body 30. As a result of the above, the battery case 100 is finished.

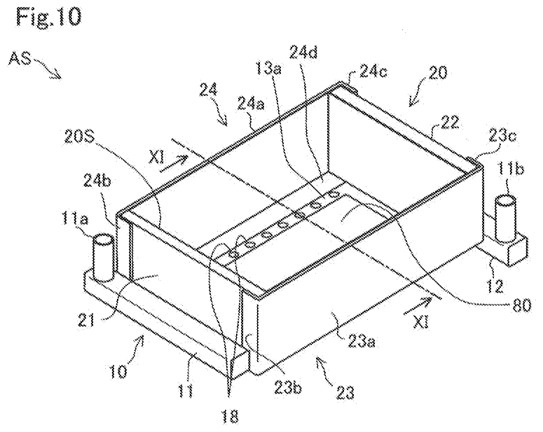

FIG. 10 is a perspective view illustrating a state where the frame body 20 is assembled to the cooler 10 with the insulation sheet 80 arranged thereon. A member in which the frame body 20 has been assembled to the cooler 10 with the insulation sheet 80 arranged thereon is referred to as an assembly AS. When the frame body 20 and the cooler 10 are assembled to the assembly AS, a case housing part 20S surrounded by the case facing face 13a of the main body part 13 and an inner circumferential face of the frame body 20 is formed. Part of the mold is housed in the case housing part 20S, and the case main body 30 is formed after injection molding.

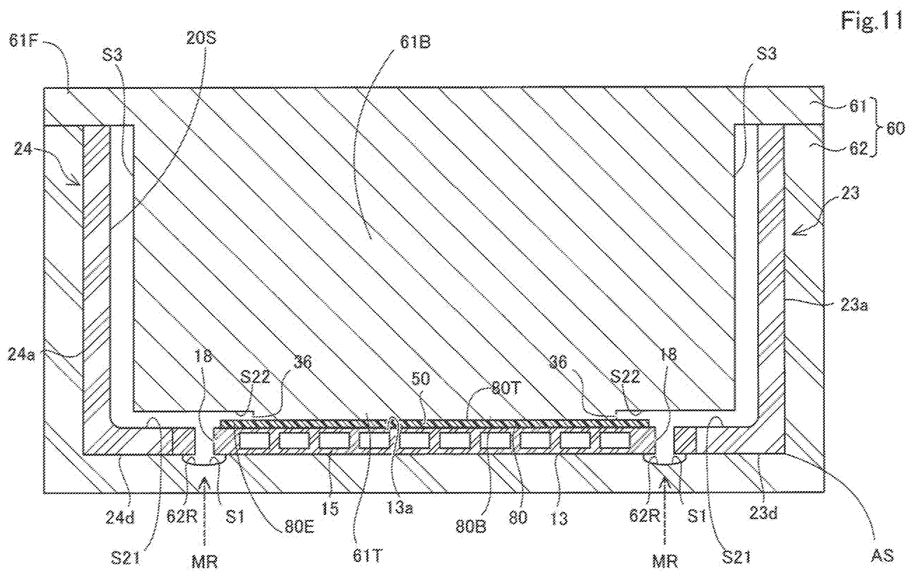

FIG. 11 is a cross-sectional view illustrating the assembly AS with a mold 60 attached thereto. A position of a cross section illustrated in FIG. 11 corresponds to an XI-XI position in FIG. 10. As illustrated in FIG. 11, the mold 60 is clamped with the assembly AS housed therein. FIG. 11 illustrates spaces S1, S21, S22 and S3 formed in the mold 60. The spaces S1, S21, S22 and S3 are spaces for forming the case main body 30, and are spaces having shapes substantially identical to the shape of the case main body 30.

As illustrated in FIG. 11, the mold 60 includes a first mold 61 and a second mold 62. The first mold 61 is a so-called core which is attached to the assembly AS so as to cover the case housing part 20S. The second mold 62 is a so-called cavity which is attached to the assembly AS so as to cover an outer circumferential face of the assembly AS. Recessed parts 62R are formed in the second mold 62. In the present embodiment, the plurality of recessed parts 62R are provided. More specifically, the recessed parts 62R the number of which is the same as the number of the fitting holes 18 formed in the cooler 10 are provided. As illustrated in FIG. 11, each recessed part 62R is arranged so as to continue to each fitting hole 18 of the cooler 10. As a result, the recessed part 62R and the fitting hole 18 form the space S1 for forming the projecting part 38 of the case bottom wall part 31. In the space S1, the recessed part 62R is a space which meets the flange part 38B of the projecting part 38, and the fitting hole 18 is a space which meets the columnar part 38A of the projecting part 38.

The first mold 61 includes a flange part 61F, a main body part 61B and protrusion parts 61T. The flange part 61F is a part which blocks the case housing part 20S of the assembly AS. The main body part 61B is a part which is housed in the case housing part 20S. The space S3 is formed between an outer circumferential face of the main body part 61B and the plate main body 23a and the plate main body 24a of the frame body 20. The space S3 is a space for forming the case sidewall part 32 of the case main body 30. Furthermore, the space 21S is formed between an outer face of the main body part 61B which faces the cooler 10, and the bottom face part 23d, the bottom face part 24d and the cooler 10, and the space S22 is formed between the outer face of the main body part 61B which faces the cooler 10, and the circumference part 80E of the insulation sheet 80. The space 21S is a space for forming the case bottom wall part 31 of the case main body 30. The space S22 is a space for forming part of the case bottom wall part 31 and forming the recessed part 31R.

The protrusion parts 61T are parts which protrude from the outer face of the main body part 61B which faces the cooler 10. The protrusion parts 61T come into contact with a surface 80T of the insulation sheet 80. The protrusion parts 61T have shapes substantially identical to the shapes of the opening parts 36, and form the opening parts 36 in the case bottom wall part 31. The protrusion parts 61T the number of which corresponds to the number of the opening parts 36 (10 in the present embodiment) are provided. The space S22 is formed in surroundings of the protrusion parts 61T. The space S22 is the space formed between the main body part 61B of the first mold 61 and the circumference part 80E of the insulation sheet 80.

An unillustrated injection device injects and fills in the spaces S1, S21, S22 and S3 formed in the mold 60 a molding material for forming the case main body 30. In the present embodiment, the molding material is injected from an unillustrated molding material flow passage which is called as a sprue to the space S1 as indicated by an arrow MR in FIG. 11, and is filled in the spaces S21, S22 and S3 in the mold 60 from the space S1.

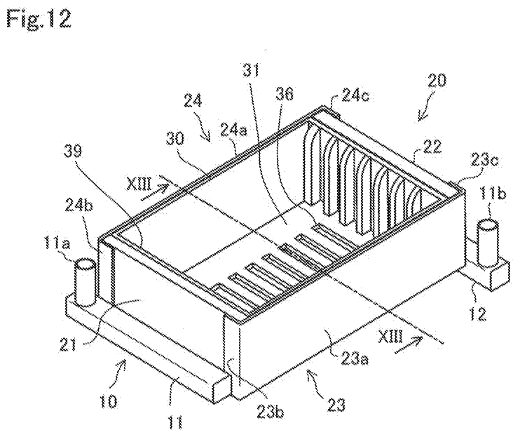

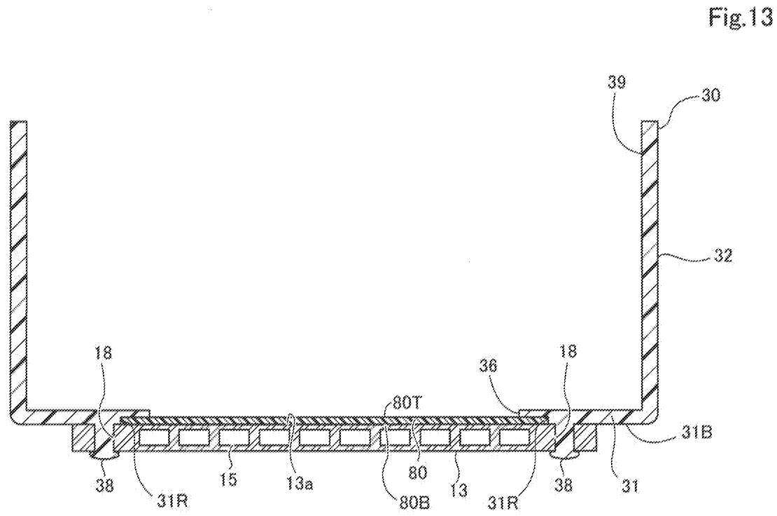

FIG. 12 is an explanatory view illustrating a state where the case main body 30 is formed in the assembly AS. FIG. 13 is a cross-sectional view of a XIII-XIII position in FIG. 12. In addition, FIG. 13 omits illustration of the frame body 20. As illustrated in FIG. 12, the case main body 30 formed by injection molding is formed in the case housing part 20S of the frame body 20 in a state where the opening parts 36 are formed in the case bottom wall part 31. As illustrated with reference to FIG. 11, when the molding material is filled in the space S1, the projecting parts 38 are formed. More specifically, when the molding material is filled in the space S1 and the fitting holes 18 of the cooler 10 as illustrated in FIG. 13, the projecting parts 38 fitted in the fitting holes 18 are formed on the outer face 31B of the case bottom wall part 31. When the molding material is further filled in the space S21, the case bottom wall part 31 is formed. When the molding material is further filled in the space S3, the case sidewall part 32 is formed. When the molding material is filled in the space S21 and the space S22, the molding material is filled in surroundings of the protrusion parts 61T of the first mold 61 while covering the circumference part 80E of the insulation sheet 80. As a result, the opening parts 36 are formed on an outer surface of the insulation sheet 80 as illustrated in FIG. 12, and the recessed part 31R which covers the circumference part 80E of the insulation sheet 80 is formed on the case bottom wall part 31 as illustrated in FIG. 13.

In the present embodiment, PET which is a resin material of the same type is used for the molding material for forming the case main body 30, and the insulation sheet 80. Hence, the molding material which has been filled in the space S22 and is in contact with the insulation sheet 80 is readily welded to the insulation sheet 80. The case main body 30 and the insulation sheet 80 are welded to each other, so that it is possible to improve adhesion of the case main body 30 and the insulation sheet 80.

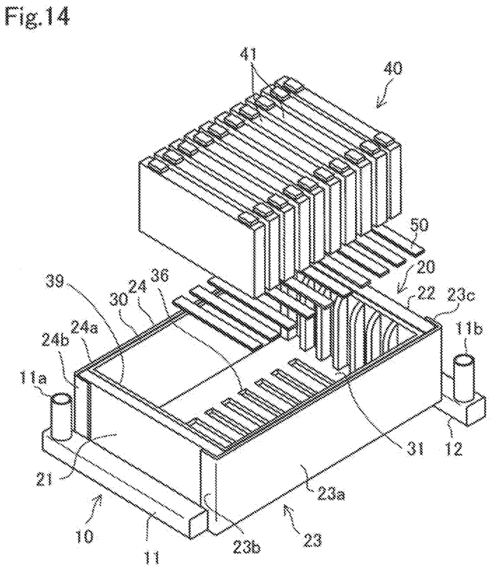

FIG. 14 is a perspective view illustrating how the heat conducting members 50 and the battery module 40 are arranged in the finished battery case 100. As illustrated in FIG. 14, the heat conducting members 50 are arranged on the opening parts 36 of the case main body 30. When the heat conducting members 50 in the paste state are coated on the opening parts 36, it is preferable to fill the heat conducting members 50 in the paste state in the opening parts 36 so as not to make a gap from a viewpoint to suppress a decrease in the insulation property. The heat conducting members 50 filled in the opening parts 36 are dried by natural drying. When the battery module 40 is assembled in the battery case 100 with the heat conducting members 50 arranged therein, the power storage device 200 is finished. In addition, the heat conducting members 50 are preferably dried after the battery module 40 is assembled from a viewpoint to closely adhere the heat conducting members 50 to the battery module 40 and the cooler 10 sufficiently.

As described above, the battery case 100 according to the present embodiment includes the case main body 30 which includes the opening parts 36 in the case bottom wall part 31, the cooler 10 which is arranged so as to face the outer face 31B of the case bottom wall part 31, and the insulation sheet 80. The insulation sheet 80 is arranged between the cooler 10 and the outer face 31B of the case bottom wall part 31 so as to cover the opening parts 36. According to the battery case 100 according to this aspect, the insulation sheet 80 blocks the opening parts 36, so that it is possible to reduce or prevent liquid water from entering the battery housing part 39 from the outside of the case main body 30 through the opening parts 36. Furthermore, the insulation sheet 80 blocks the opening parts 36 on the outer face 31B of the case bottom wall part 31, so that it is possible to enhance the insulation property between the battery module 40 and the cooler 10.

According to the battery case 100 according to the present embodiment, the insulation sheet 80 contains PET. The insulation sheet 80 has the insulation property, the waterproof property and the thermal conductivity, so that it is possible to reduce or prevent electric conduction between the battery module 40 and the cooler 10, and enhance the heat radiation capability of the battery module 40.

According to the battery case 100 according to the present embodiment, the insulation sheet 80 and the case main body 30 contain PET which is the same resin material. The outer face 31B of the case bottom wall part 31 and the insulation sheet 80 are welded to each other, so that it is possible to improve the adhesion of the case main body 30 and the insulation sheet 80. Consequently, it is possible to reduce or prevent the case main body 30 from falling from the cooler 10, and improve the strength of the battery case 100.

According to the battery case 100 according to the present embodiment, the outer face 31B of the case bottom wall part 31 includes the recessed part 31R in the surroundings of the opening parts 36. The recessed part 31R is formed over the range including the arrangement area 36E in which the opening parts 36 are arranged. The insulation sheet 80 is housed in the recessed part 31R such that the face of the insulation sheet 80 which faces the cooler 10 is flush with the outer face 31B of the case bottom wall part 31. According to the battery case 100 according to this aspect, the insulation sheet 80 is housed in the recessed part 31R, so that it is possible to increase the contact area of the case main body 30 and the insulation sheet 80 while the insulation sheet 80 blocks the opening parts 36, and improve the adhesiveness of the case main body 30 and the insulation sheet 80. The insulation sheet 80 is housed in the recessed part 31R, so that it is possible to arrange the insulation sheet 80 between the cooler 10 and the outer face 31B of the case bottom wall part 31 without increasing the thickness of the case bottom wall part 31.

According to the battery case 100 according to the present embodiment, the case main body 30 further includes the projecting parts 38 which project from the outer face 31B of the case bottom wall part 31, and the cooler 10 further includes the fitting holes 18 for fitting with the projecting parts 38. The projecting parts 38 of the case main body 30 and the fitting holes 18 of the cooler 10 fit, so that it is possible to reduce or prevent the case main body 30 from falling from the cooler 10, and improve the strength of the battery case 100.

According to the method for manufacturing the battery case of the present embodiment, in a process of forming the case main body 30 by injection molding, the molding material is filled in the mold 60 in which the cooler 10 with the insulation sheet 80 arranged thereon is assembled, and the opening parts 36 are formed above the surface 80T of the insulation sheet 80. As a result, the opening parts 36 are blocked by the surface 80T of the insulation sheet 80. Consequently, it is possible to reduce or prevent liquid water from entering the battery housing part 39 from the outside of the case main body 30 through the opening parts 36. Furthermore, the insulation sheet 80 blocks the opening parts 36, so that it is possible to enhance the insulation property between the battery module 40 and the cooler 10.

According to the method for manufacturing the battery case of the present embodiment, in the process of forming the case main body 30 by injection molding, the molding material is filled in the spaces S21 and S22, and thereby the molding material is filled so as to cover the circumference part 80E of the insulation sheet 80. Consequently, it is possible to increase the contact area of the case main body 30 and the insulation sheet 80, and improve the adhesiveness of the case main body 30 and the insulation sheet 80. Furthermore, when the molding material is filled so as to cover the circumference part 80E of the insulation sheet 80, the insulation sheet 80 is housed in the recessed part 31R formed on the outer face 31B of the case bottom wall part 31. The insulation sheet 80 is housed in the recessed part 31R, so that it is possible to arrange the insulation sheet 80 between the cooler 10 and the case main body 30 without increasing the thickness of the case bottom wall part 31.

According to the method for manufacturing the battery case 100 according to the present embodiment, in the process of forming the case main body 30 by injection molding, the molding material is filled in the fitting holes 18 formed in the cooler 10 to form the case main body 30 in a state where the projecting parts 38 which are part of the case main body 30 are fitted in the fitting holes 18. The projecting parts 38 of the case main body 30 and the fitting holes 18 of the cooler 10 fit, so that it is possible to reduce or prevent the case main body 30 from falling from the cooler 10, and improve the strength of the battery case 100.

B. Another Embodiment

(B1) In the above embodiment, the case main body 30 is formed by using PET which is the material of the same type as the material contained in the insulation sheet 80. By contrast with this, in a case where, for example, the adhesion of the case main body 30 and the insulation sheet 80 is sufficient, the material of the case main body 30 may not be the resin material of the same type as that of the insulation sheet 80.

(B2) The above embodiment has described the example where the number of the opening parts 36 is the same as the number of the battery cells 41 of the battery module 40. By contrast with this, for example, the one opening part 36 may be provided in the arrangement area 36E, the number of the opening parts 36 may be smaller or larger than the number of the battery cells 41, and the opening parts 36 the number of which is different from the number of the battery cells 41 may be provided. In this case, the insulation sheet 80 covers all the arranged opening parts 36, and thereby blocks the opening parts 36.

(B3) The above embodiment has described the example where the recessed part 31R over the range including the arrangement area 36E is formed on the outer face 31B of the case bottom wall part 31. By contrast with this, the recessed part 31R may not be provided. In this case, the insulation sheet 80 may be arranged between the case facing face 13a of the cooler 10 and the outer face 31B of the case bottom wall part 31 in a state where, for example, the insulation sheet 80 comes into contact with the outer face 31B of the case bottom wall part 31.

(B4) The above embodiment has described the example where the case main body 30 and the insulation sheet 80 contain PET of the same resin material. By contrast with this, the case main body 30 and the insulation sheet 80 do not necessarily need to contain the same resin material, and may contain different resin materials.

The present disclosure is not limited to the above embodiments, and may be realized by various configurations without departing from the gist of the present disclosure. For example, a technical feature in each embodiment may be replaced or combined as appropriate to solve part or entirety of the above-described problem or achieve part or entirety of the above-described effect. Furthermore, unless each technical feature is described as indispensable in this description, each technical feature can be deleted as appropriate. For example, the present disclosure may be realized by aspects described below.

(1) One aspect of the present disclosure provides a battery case. This battery case includes: a case main body that includes a case bottom wall part, and a case sidewall part, wherein the case sidewall part is connected to a circumference part of the case bottom wall part and defines together with the case bottom wall part a battery housing part for housing a battery module, wherein the case bottom wall part includes an opening part, wherein the battery housing part communicates with an outside of the case main body through the opening part; a cooler that is arranged so as to face an outer side of the case bottom wall part; and an insulation sheet that covers the opening part, wherein the insulation sheet is arranged between the cooler and the case bottom wall part.

According to the battery case of this aspect, the insulation sheet is arranged between the cooler and the case bottom wall part and covers the opening part, and thereby the opening part is blocked by the insulation sheet, so that it is possible to reduce or prevent liquid water from entering the battery housing part from the outside of the case main body through the opening part.

(2) In the battery case of the above aspect, the insulation sheet may contain at least one of PET and PP.

According to the battery case of this aspect, the insulation sheet has an insulation property, a waterproof property and thermal conductivity, so that it is possible to reduce or prevent electric conduction between the battery module and the cooler, and enhance heat radiation capability of the battery module.

(3) In the battery case of the above aspect, the insulation sheet and the case main body may contain a same resin material, and be welded to each other.

According to the battery case of this aspect, the case bottom wall part and the insulation sheet are welded, so that it is possible to improve adhesion of the case main body and the insulation sheet.

(4) In the battery case of the above aspect, an outer face of the case bottom wall part may include a recessed part in surroundings of the opening part. The insulation sheet may be housed in the recessed part.

According to the battery case of this aspect, the insulation sheet is housed in the recessed part, so that it is possible to increase a contact area of the case main body and the insulation sheet while the insulation sheet blocks the opening part, and improve adhesiveness of the case main body and the insulation sheet.

(5) In the battery case of the above aspect, the case main body may further include a projecting portion that projects outwardly from an outer face of the case bottom wall part. The cooler may further include a fitting hole for fitting with the projecting portion.

According to the battery case of this aspect, the projecting part of the case main body and the fitting hole of the cooler fit, so that it is possible to reduce or prevent the case main body from falling from the cooler, and improve strength of the battery case.

(6) Another aspect of the present disclosure provides a method for manufacturing a battery case. This method for manufacturing the battery case includes the steps of: arranging an insulation sheet on a surface of a cooler; providing in a mold the cooler with the insulation sheet arranged thereon; and filling a molding material into the mold in which the cooler is provided, and forming a case main body, wherein the case main body includes a battery housing part and an opening part that is arranged on a surface of the insulation sheet, wherein the battery housing part communicates with an outside of the case main body through the opening part.

According to the method for manufacturing the battery case of this aspect, the opening part is blocked by the surface of the insulation sheet. Consequently, it is possible to reduce or prevent liquid water from entering an inside of the case main body from the outside of the case main body through the opening part.

(7) According to the method for manufacturing the battery case of the above aspect, in the step of forming the case main body, the molding material may be filled into the mold so as to cover at least a circumference part of the insulation sheet.

According to the method for manufacturing the battery case of this aspect, the molding material is filled so as to cover the circumference part of the insulation sheet, so that it is possible to increase the contact area of the case main body and the insulation sheet, and improve the adhesiveness of the case main body and the insulation sheet.

(8) According to the method for manufacturing the battery case of the above aspect, in the step of forming the case main body, the molding material may be further filled in a fitting hole provided in the cooler, and the case main body may be formed, wherein a part of the case main body is fitted in the fitting hole.

According to the method for manufacturing the battery case of this aspect, the projecting part of the case main body and the fitting hole of the cooler fit, so that it is possible to reduce or prevent the case main body from falling from the cooler.

The present disclosure can be also realized as various aspects other than the battery case and the method for manufacturing the battery case. The present disclosure can be realized as aspects such as a power storage device, a movable body which includes the battery case or the power storage device, a method for manufacturing the power storage device and the method for manufacturing the movable body.

What is claimed is:

1. A battery case comprising:
a case main body that includes a case bottom wall part and a case sidewall part, wherein the case sidewall part is connected to a circumference part of the case bottom wall part and defines together with the case bottom wall part a battery housing part for housing a battery module, wherein the case bottom wall part includes an opening part, wherein the battery housing part communicates with an outside of the case main body through the opening part;
a cooler that is arranged so as to face an outer side of the case bottom wall part; and
an insulation sheet that covers the opening part, wherein the insulation sheet is arranged between the cooler and the case bottom wall part.

2. The battery case according to claim 1, wherein the insulation sheet contains at least one of PET and PP.

3. The battery case according to claim 1, wherein the insulation sheet and the case main body contain a same resin material, and are welded to each other.

4. The battery case according to claims 1, wherein
an outer face of the case bottom wall part includes a recessed part in surroundings of the opening part, and
the insulation sheet is housed in the recessed part.

5. The battery case according to claims 1, wherein
the case main body further includes a projecting portion that projects outwardly from an outer face of the case bottom wall part, and
the cooler further includes a fitting hole for fitting with the projecting portion.

6. A method for manufacturing a battery case comprising the steps of:
arranging an insulation sheet on a surface of a cooler;
providing in a mold the cooler with the insulation sheet arranged thereon; and
filling a molding material into the mold in which the cooler is provided, and forming a case main body, wherein the case main body includes a battery housing part and an opening part that is arranged on a surface of the insulation sheet, wherein the battery housing part communicates with an outside of the case main body through the opening part.

7. The method for manufacturing the battery case according to claim 6, wherein, in the step of forming the case main body, the molding material is filled into the mold so as to cover at least a circumference part of the insulation sheet.

8. The method for manufacturing the battery case according to claim 6, wherein, in the step of forming the case main body,
the molding material is further filled into a fitting hole formed on the cooler, and
the case main body is formed, wherein a part of the case main body is fitted in the fitting hole.
